(19) United States
(12) Patent Application Publication
(10) Pub. No.: US 2011/0320215 A1
(43) Pub. Date: Dec. 29, 2011

(54) SYSTEM, METHOD, AND APPARATUS FOR CONVEYING TELEFAMILIARIZATION OF A REMOTE LOCATION

(76) Inventors: Jeff D. Cooper, Great Falls, VA (US); John K. Cooper, Great Falls, VA (US)

(21) Appl. No.: 13/085,751

(22) Filed: Apr. 13, 2011

Related U.S. Application Data
(60) Provisional application No. 61/358,373, filed on Jun. 24, 2010.

(51) Int. Cl. G06Q 99/00

(52) U.S. Cl. 705/1.1

(57) ABSTRACT

A system, method and apparatus for providing TeleFamiliarization of a remote location to a plurality of users connected to a network is provided. The system comprises a plurality of real time sensory data gathering devices that can be manipulated remotely by the users of the system. The real time data provided by this system permits users to observe social traffic and patronage of a participating location remotely. The data assists users in their decision making process by allowing the user to assess the genre of a venue, assess patronage (quantity and quality), assess the venue's facilities and layout (handicap accessible, bathroom locations, menu), and to assist in determining whether the user will ultimately attend the venue. The system further comprises an interactive floor plan of the premise which will disclose to the users the locations of the installed sensory data gathering devices.

### RELATIONSHIP TO OTHER APPLICATIONS

This application claims the full benefits of provisional application 61/358,373; filed under the same inventors on Jun. 24, 2010; the application is incorporated by reference herein, in its entirety, for all purposes.

### BACKGROUND

1. Field of the Invention

Embodiments of this invention relate generally to computers, and, more particularly, to a method and apparatus for familiarizing a user to a remote location.

2. Description of Related Art

Often times, a consumer may wish to visit a favorite restaurant or bar only to be confronted with less than desirable conditions. For example, a consumer may visit a restaurant only to find, upon arrival, crowded conditions and long wait times; or a consumer may visit a bar in search of meeting new friends, but finds that it is sparsely populated. As a result, the consumer ends up traveling from place to place until he finds the desired conditions (e.g., a shorter wait time at a restaurant or a densely populated bar), thereby potentially wasting a large amount of time that could be spent on dining or conversing with others.

### SUMMARY OF EMBODIMENTS OF THE INVENTION

The objectives of the present invention are to eliminate the need for physical travel to a location in order to ascertain the salient features of that location. For example, a user may wish to visit a favorite restaurant only to find upon arrival crowded conditions and long wait times. In another example, an individual wishes to visit a bar in search of meeting new friends, but finds that it is sparsely populated. TeleFamiliarization eliminates the need for the individual to travel from place to place in search of what they desire.

In its broadest sense, TeleFamilarization is the conveying of real-time sensory data from a remote location (e.g., a bar, restaurant, club, lounge, theatre, stadium or playhouse, a coffee shop, an educational establishment and the like). Thus, allowing the user to become acquainted with the source location without having physically visited said location.

TeleFamilarization is a method of enabling a person to feel as if he or she were present at a selected location (other than his or her present location), by providing stimuli or sensory information, which would be perceived by the person if he or she were physically at the location.

TeleFamilarization differs from security surveillance, videoconferencing, collaborative style computer aided meeting/conference tool or application in that it does not involve intercommunication between parties at different nodes of the system. In one embodiment, TeleFamiliarization data located at a remote location is only available during hours of operation. Using the TeleFamilarization system, the user can interact with the remote location by command (to move cameras, to listen to sounds, or to view a floor map, or gather additional data about a remote location).

What is needed is a system that would allow users to virtually visit, rather than physically visit, a location as a means for the user to witness the conditions of the location first hand. Using this system, users can make informed decisions to visit or avoid a location. Users may also use the system to explore and familiarize themselves with an establishment which they have never visited. This is done by means of an interactive floor plan that is operatively connected to an apparatus for collecting stimuli or sensory data in real time of the location's environment. This system would eliminate the need for physical travel to a location to ascertain its environment or extent of its social traffic (commonly referred to as “bar hopping”). TeleFamilarization will change how an individual makes a decision on which establishment they wish to visit or avoid. TeleFamiliarization also benefits the establishment transmitting the sensory information in that it makes available to patrons and potential patrons an inducement to patronize said establishment.

Embodiments of the invention describe a TeleFamiliarization system, which enables its user to select a location remotely from his or her own location and obtain TeleFamiliarizing data from the remote location. The location is both registered with the TeleFamiliarization system and properly equipped to gather and transmit TeleFamiliarizing data for that location to the user.

TeleFamiliarizing data comprises both multimedia and non-multimedia information. The multimedia information (e.g., audio and video), is real time data because a realistic sense of presence at a remote location requires a sense of the present moment for the sights and the sounds the user perceives. The non-multimedia data associated with the remote location can include descriptive, historical, anecdotal or critical information. The real time multimedia TeleFamiliarizing information for a remote location may be obtained by the user from more then one view or place within the remote location. The user may select or receive such information from more then one scene randomly or by the use of non-multimedia data for the remote location, which would assist the user in making a decision regarding scene selection. Further, the user could select to receive automated random scene selections.

The real time multimedia TeleFamiliarization information is obtained at a specific location by multimedia data gathering apparatuses, such as video cameras, microphones, television cameras, web cameras, etc. There may be one or a plurality of such devices placed in said location, and the devices placed in the remote location and the devices themselves may be fixed or manipulable. The output of these devices is linked to a network directly or by means of a network-enabled computing device.

The TeleFamiliarization system may be implemented on a plurality of networks, which may include but are not limited to the Internet, private networks such as cable television systems, wireless data networks, mobile telephone systems, and the like.

The TeleFamiliarization data is obtained from the one or more remote sites and may be transmitted by these networks to one or more geographically centralized TeleFamiliarization Hub Sites. The geographically centralized TeleFamiliarization Hub Sites control the flow of TeleFamiliarization data from the remote locations in the manner of a command center, such that TeleFamiliarization data is only transmitted from a remote location when commanded to do so by a TeleFamiliarization Hub Site.

TeleFamiliarization Nodes may receive requests for TeleFamiliarization data from a plurality of end users, which may comprise a variety of multimedia-enabled devices, such as wired or wireless computers, telephones, mobile phone, PDA's, handheld computing devices and the like. The end user devices access the TeleFamiliarization Nodes via web portals.

The TeleFamiliarization Node is capable of formatting the TeleFamiliarization data requested by the end user to best utilize the requesting devices multimedia capabilities.

In addition to the real time multimedia data obtained from a remote site upon request, the TeleFamiliarization Node can also provide system wide information to the end user.

The TeleFamiliarization system may comprise a plurality of regionally deployed TeleFamiliarization Nodes, each having the above stated capabilities and features, which are themselves, interactive with each other.

In one aspect of the present invention, a method is provided. The method includes selecting a location from among a plurality of locations via a computing device, wherein the plurality of locations are geographically remote from the computing device, and wherein the computing device is assignable to a first status or a second status. The method also includes transmitting a request, via the computing device, to activate one or more electronic devices located at the selected location via the computing device. The method further includes receiving at least one of a live audio stream and/or a live video stream of the selected location from the one or more electronic devices in response to remotely activating the one or more electronic devices, wherein features of the one or more electronic devices are controllable when the computing device is assigned to the first status.

In another aspect of the present invention, another method is provided. The method includes receiving a request from a computing device located at a first location to activate a electronic device located at a second location, wherein the first location is geographically remote from the second location. The method also includes determining whether the computing device is assigned to a first status or a second status, and transmitting at least one of a live audio stream and/or a live video stream of the second location via the electronic device to the computing device located at the first location. The method further includes providing the ability control the at least one of the live audio stream and/or the live video stream via the electronic device in response to determining that the computing device is assigned to the first status.

In yet another aspect of the present invention, a system is provided. The system comprises one or more TeleFamiliarization Nodes, the one or more TeleFamiliarization Nodes comprising one or more electronic devices. The one or more TeleFamiliarization Nodes are configured to receive a request to activate the one or more electronic devices, wherein the request is received from a location geographically remote from the TeleFamiliarization Nodes. The one or more TeleFamiliarization nodes are also configured to determine whether the request is assigned to a first status or a second status, and transmit at least one of a live audio stream and/or a live video stream via the one or more electronic devices. The one or more TeleFamiliarization nodes are further configured to provide the ability to control at least one of the live audio stream and/or the live video stream via the one or more electronic devices in response to determining that the request is assigned to the first status.

In yet another aspect of the present invention, an apparatus is provided. The apparatus includes a computing device configured to select a location from among a plurality of locations, wherein the plurality of locations are geographically remote from the computing device, and wherein the computing device is assignable to a first status or a second status. The computing device is also configured to transmit a request configured to activate one or more electronic devices located at the selected location. The computing device is further configured to receive at least one of a live audio stream and/or a live video stream of the selected location from the one or more electronic devices in response to remotely activating the one or more electronic devices, wherein features of the one or more electronic devices are controllable when the computing device is assigned to the first status.

### BRIEF DESCRIPTION OF THE DRAWINGS

The present invention is illustrated by way of example and not by any way of limitation in the figures of the accompanying drawings in which like reference numerals refer to similar elements and in which:

FIG. 1 illustrates a simplified block diagram of a TeleFamiliarization system according to one embodiment;

FIG. 2 illustrates an example HyperText Markup Language (HTML) page representing a home page for a TeleFamiliarization system according to one embodiment;

FIG. 3 illustrates an example HTML page representing a lookup page for a TeleFamiliarization system according to one embodiment;

FIG. 4 illustrates an example HTML page representing a landing page for a TeleFamiliarization system according to one embodiment;

FIG. 5 illustrates an example HTML page illustrating a venue floor plan according to one embodiment; and

FIG. 6 illustrates an example HTML page illustrating a TeleFamiliarization Node component control center according to one embodiment.

### DETAILED DESCRIPTION

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time consuming, but would nevertheless be a routine undertaking of engineering for those of ordinary skill in the art having the benefit of this disclosure.

In accordance with the present invention, the components, process steps, and/or data structures may be implemented using various types of operating systems, computer platforms, computer programs, and/or general purpose machines.

Embodiments of the present invention are described herein in the context of a system and method for providing users a TeleFamiliarization, via a web portal, of a remote establishment.

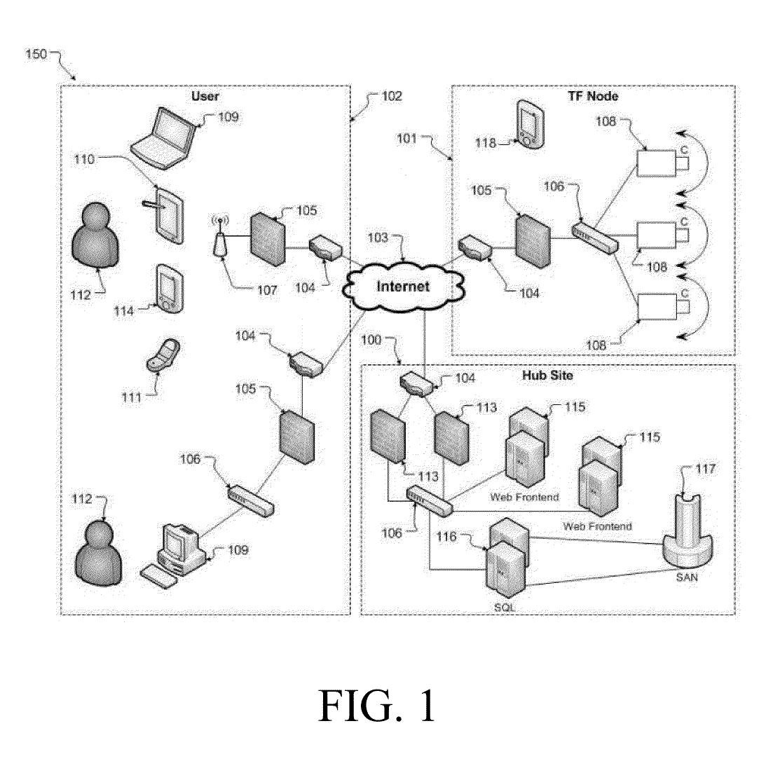

Turning now to FIG. 1, a simplified block diagram of a TeleFamiliarization (TF) system 150, in accordance with an embodiment of the invention, is illustrated. The system 150 may be comprised of several different components that interact with each other to share or present information to the end user about a selected locale. In one embodiment, the system includes at least four components; a Hub Site 100, a TF Node 101 that broadcasts or presents information, a plurality of user-operated devices 102 and a network 103. The network 103 may be a local area network (LAN), wide area network (WAN), personal network, company intranet or company network, the Internet, or the like. Each of these components 100, 101, 102, 103 may be a collection of subcomponents that work together to provide a service or set of data back to another component of the overall system 150.

The Hub Site 100 allows the user-operated devices 102 to select a locale to be familiarized with and also act as a receiving end for the audio and video streams initiated at the TF Nodes 101. To handle the interaction between the user-operated devices 102 and the TF Nodes 101, the Hub Site 100, in one embodiment, uses a set of redundant network architectures to insure that the service is up and running in the event of a network failure. The redundant network architectures may involve multiple connections to the network 103. Each of the connections may be connected to a router 104 that is then shared across a set of redundant firewall 113 systems, thereby providing system resiliency in the event of a network failure on the network 103 or a local failure with a networking component connected to the network 103. The firewalls 113 may be connected into a local network switch 106 infrastructure that connects to servers 115, 116 located at the Hub Site 100. The servers 115, 116 consist of web server farms 115 that handle requests initiated by the user-operated devices 102 and provide data back to the user-operated devices 102 as well as termination end-points for the components at the TF Node 101. The web server farms 115 retain minimal amounts of data as most of the system's 150 data resides in databases that are accessed through a set of clustered SQL servers 116 that share a common file system stored on a disk-based system like a storage-area network (SAN) 117 or other storage technology. In one embodiment, this backend database storage system 117 could be replaced or outsourced to other storage solutions, such as through Cloud Storage technologies.

The TF Node 101 is a locale of interest that has one or more audio and/or video devices installed and relays audio and/or video data generated from the audio and/or video devices back to the Hub Site 100 at a user's request. It is noted that the system may include a plurality of TF Nodes 101, each representing a different locale of interest. The audio and/or video data streams back to the Hub Site 100, and ultimately, back to the user-operated devices 102 when such a device 102 has requested to view or control a stream of information from a particular TF Node 101. This minimizes the overall system load and lessens the potential waste of traffic or resources at a TF Node 101 as well.

In one embodiment, a TF Node 101 is connected to the network 103 via a router 104, which is connected to the firewall 105 before connecting to a locale's network infrastructure 106. In another embodiment, the TF Node 101 may be consolidated to an all-in-one device that provides internet connectivity, firewall capabilities as well as additional network ports to allow additional devices to connect to the network 103.

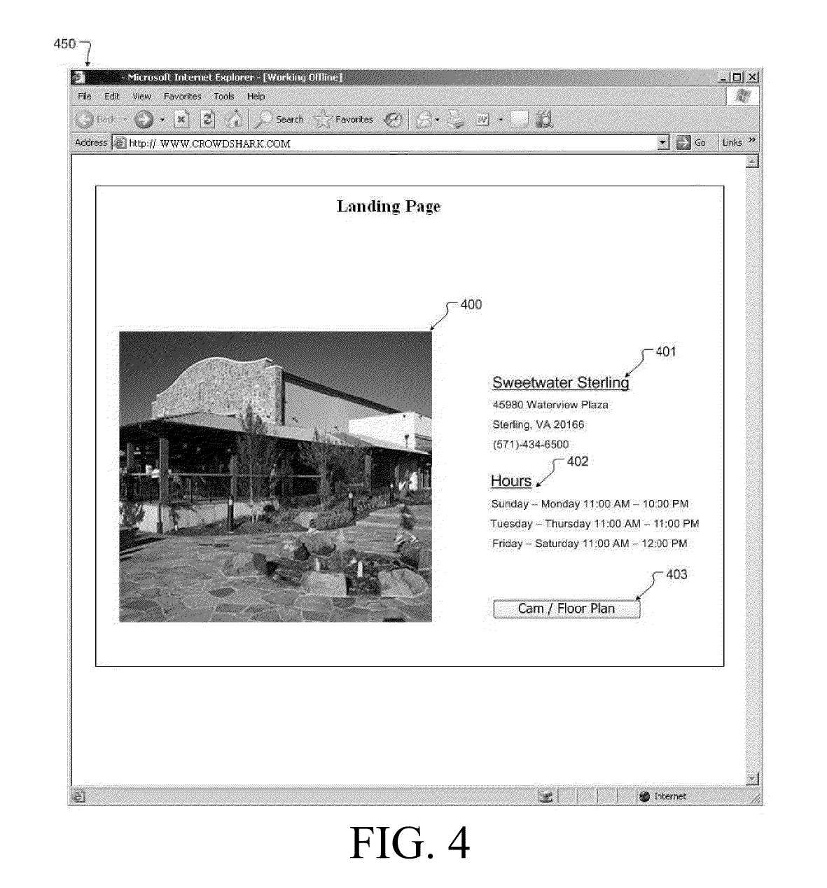

Each TF Node 101 may include one or more audio/video devices 108 that stream audio and video information to a remote network location. In one embodiment, the audio/video devices 108 may be Pan/Tilt/Zoom (PTZ) network cameras that stream audio and video information to the remote network location. The system 150 also provides for a user to stream live data from a TF Node 101 back to the Hub Site 100 and have that stream of data be presented on the TF Node's 101 landing page 450 (as shown in FIG. 4). In one embodiment, a mobile device 118 located at the TF Node 101 may be used to initiate the data stream to the Hub Site 100. In this case, a user may login into the system 150 via the mobile device 118, select the TF Node 101 they are presently in, and request that they want to stream the information back to the Hub Site 100. Once the user has been authenticated, the system 150 may use location information from the mobile device 118 (e.g., by using global positioning system (GPS) located on the mobile device 118) to validate that the user is at or at least near the TF Node 101 that the user has requested to stream from. This will prevent users from claiming they are in one location and stream from another location or venue.

The individual 112 has the ability to access the system 150 from any network-enabled device or device that is connected to the network 150 that has access to the system 150. This can include interconnections in the home, coffee shop, workplace or on the go (via a mobile device). Examples of this type of access include, but are not limited to: private wireless systems 107 (e.g., Bluetooth, 802.11 and WiMax, mobile phone wireless networks (e.g., Verizon, AT&T, T-mobile, U.S. Cellular, etc.)) or traditional wired connectivity.

The system 150 presents data to the user 112 in the format best suited for the device that the user is connecting from, thus providing an optimized presentation of information to the user (e.g., via a cell phone 111, desktop or notebook computer 109, tablet computer 110, or personal data assistant (PDA) 114), while the look and feel will remain the same and the core components available, the layout of the screen and data presented will be optimized for screen size and user's system's capabilities.

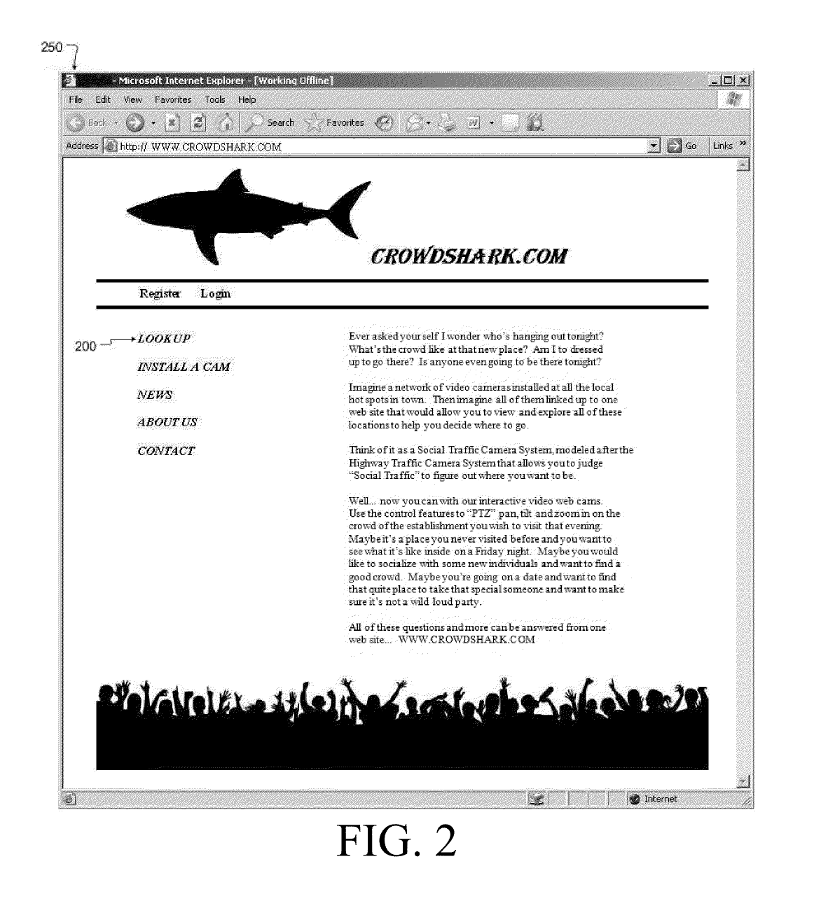

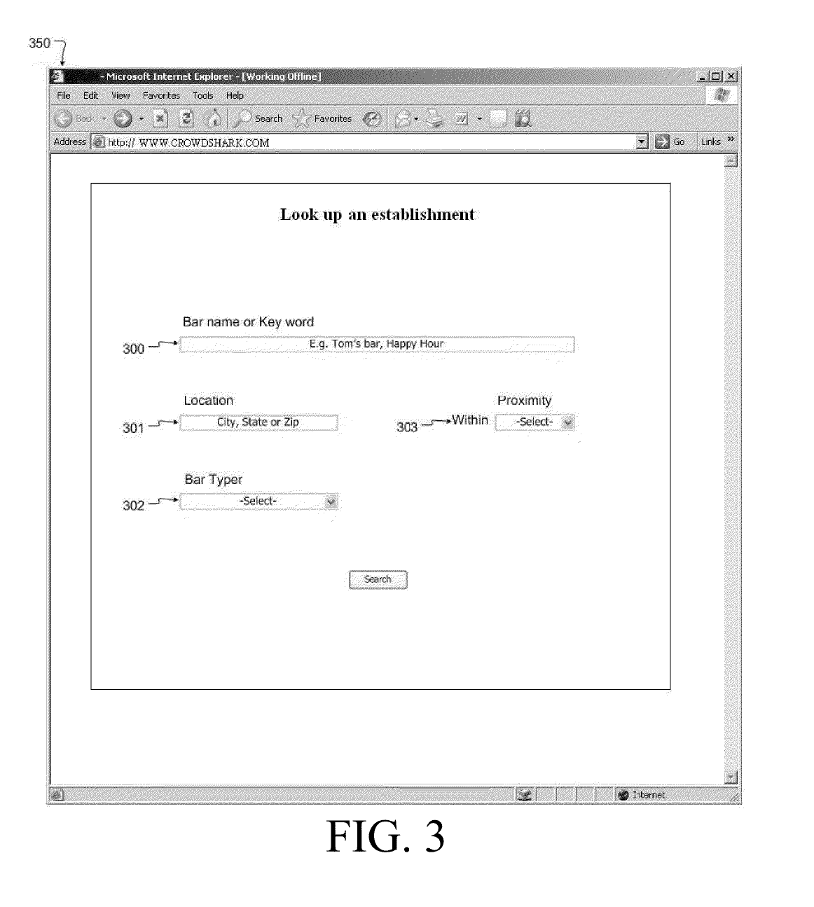

Turning now to FIG. 2, an example HyperText Markup Language (HTML) page representing a home page 250 for the TeleFamiliarization system 150, in accordance to an embodiment of the invention, is illustrated. In one embodiment, the Hub Site 100 hosts a series of web pages that help direct the end user 112 to the landing page 450 (as shown in FIG. 4) for each locale that is enrolled in the system 150. The home (or portal) page 250 acts as the initial starting point for an end user's 112 interaction with the system 150. As shown, the home page 250 includes a basic greeting and information 202 on the system's 150 overall use. The home page 250 also acts as the key point to allow a user 112 to find a locale or facility that they are interested in familiarizing themselves with remotely. In one embodiment, a user 112 can search for a locale by clicking on a designated “lookup” button or tool 200 displayed on the home page 250. Once the user 112 activates the lookup tool 200 (e.g., by clicking on a button or link that activates the lookup tool 200), the user 112 will be directed to the locale or establishment lookup page 250, as shown in FIG. 3.

Turning now to FIG. 3, an example HTML page representing a lookup page 350 for a TeleFamiliarization system 150, in accordance to an embodiment of the invention, is illustrated. The lookup page 350 may include several search options that a user 112 can use to narrow a search for a particular establishment of interest. For example, the lookup page 350 may include the following fields that can be used to narrow a search for a particular locale: venue name or keyword field 300 that allows the user 112 to enter part of a locations name or main theme (e.g., “Irish Pub”), a location field 301, which allows a user 112 to select venues by state, city, and/or zipcode to find a specific venue in a particular geographic location, and a proximity field 303, which allows a user 112 to search for a locale within a short distance or radius from a particular location (e.g., five miles from zip code 22313), a venue type field 302, which allows a user 112 to search for a locale based on the locale's primary mode of business (e.g., a bar, restaurant, club, lounge, theatre, stadium or playhouse, a coffee shop, an educational establishment and the like). It is noted that the search fields 300, 301, 302, 303 illustrated in FIG. 3 are merely illustrative, as embodiments of the invention may be modified to provide for locale searching using other/additional search criteria.

Upon entering the search criteria, a user 112 may initiate and submit a request to the Hub Site 100 to return the search results by clicking on the Submit button 205. Once the Hub Site 100 returns the results, the results may be shown to the user 112 via a results page (not shown).

Turning now to FIG. 4, an example HTML page representing a venue landing page 450 for a TeleFamiliarization system 150, in accordance to an embodiment of the invention, is illustrated. The venue landing page 450 is the primary page for a given venue or locale that describes the venues characteristics and provides an overview of the establishment. This includes information such as a possible picture of the location 400, the venue's name 401, and additional information, such as hours of operation 402, the venue's address 401, and/or contact information (not shown). It is noted that additional information may also be presented about the venue (or group of venues if the establishment is part of a larger chain or conglomerate), as well as possible links to web sites located outside the Hub Site 100 (e.g., the venue's own web site or to advertisement banner backend systems). The venue operator may have the choice to add additional features to the landing page 450, including, but not limited to: displaying a menu, allowing reservations to be booked, placing take out orders, and purchasing of tickets for a particular event.

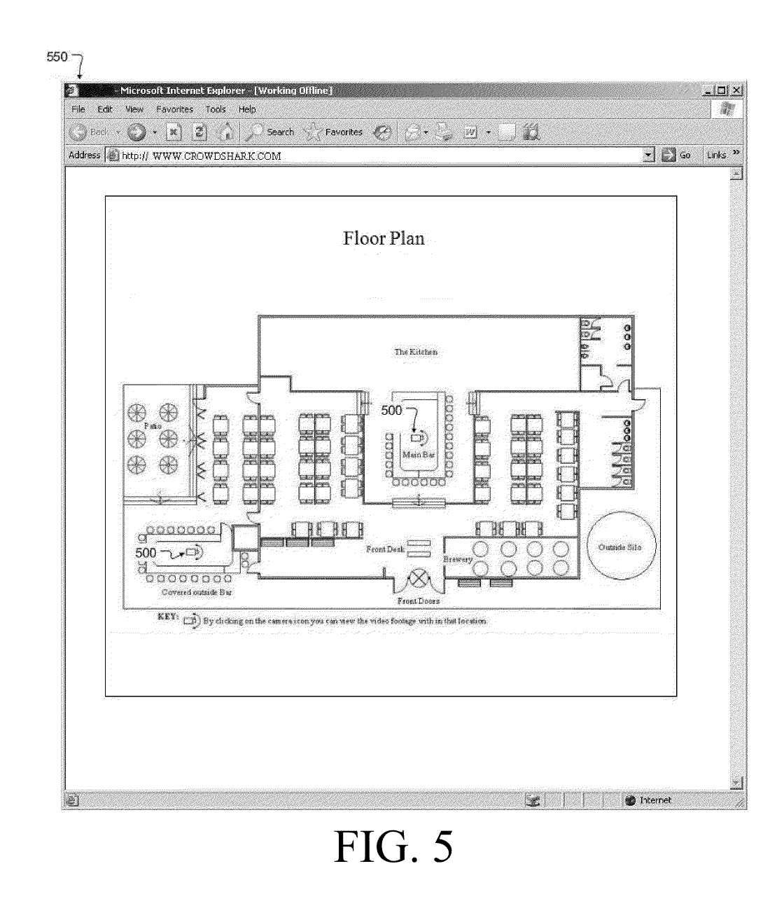

In one embodiment, the landing page 450 also includes buttons/links 403 to the floor plan of the venue. The venue floor plan, as will be discussed with reference to FIG. 5, may include camera locations and also provide the opportunity for registered users to participate in the transmission of TeleFamiliarization data via the TF Node 101.

Turning now to FIG. 5, an example HTML page illustrating the venue floor plan 550, in accordance to an embodiment of the invention, is illustrated. The venue floor plan 550 provides a user 112 with the ability to see the layout of a venue that they have searched for (e.g., via the lookup page 350) and/or selected (e.g., via the landing page 450) so that they can familiarize themselves with various attributes of the establishment, such as bathroom locations, multiple exits or fire exits from the building, kitchen location, and possibly the availability of indoor and/or outdoor seating. While this provides a basic level of familiarizing the user 112 with the remote locale, the user 112 can become further immersed in the “feel or sense” for a particular venue by engaging the audio and/or video devices 108 within the TF Node 101. Accordingly, the venue floor plan 550 may also include TeleFamiliarization collection components 500. Each component 500 represents an audio and/or video device 108 located in a particular location of the venue. As shown, an audio and/or video device 108 is located in the Main Bar and the Covered Outside Bar of the venue.

By activating the components 500 (e.g. by clicking on a particular component 500), the user 112 may initiate an audio and/or video stream from the venue. The stream may be viewed by the user 112 via a user-operated device 109, 110, 111, 114. In addition, the user 112 may be given the ability to control the direction and zoom of the installed video and/or audio device 108 located at the TF Node 101, thereby giving the user 112 a TeleFamiliarization experience that is akin to being at the venue itself.

The particular number of audio and/or video devices 108 may depend upon a variety of factors, such as information to be viewed and size of the establishment. The cameras may also be of different types, including, but not limited to a still camera without audio capabilities, a video camera with low light or night vision, a camera with audio, a video camera with PTZ capabilities, or any combination there of. It is noted that the particular components and configurations of the cameras are not essential to embodiments of the present invention.

In one embodiment, the audio and/or video devices 108 may capture real time video images, still images, and optionally, audio information. In one embodiment, the captured real time multimedia information may be transmitted back to the Hub Sites 100 using a compression method delivered by a multimedia standard, such as MPEG4 or utilize platforms such as Adobe Flash Video (FLV), HTML 5 or Microsoft's Silverlight. The TeleFamiliarization system 150 may be built in a modular manner such that this method of transmission can be easily replaced by other methods of delivery back to the Hub Sites 100.

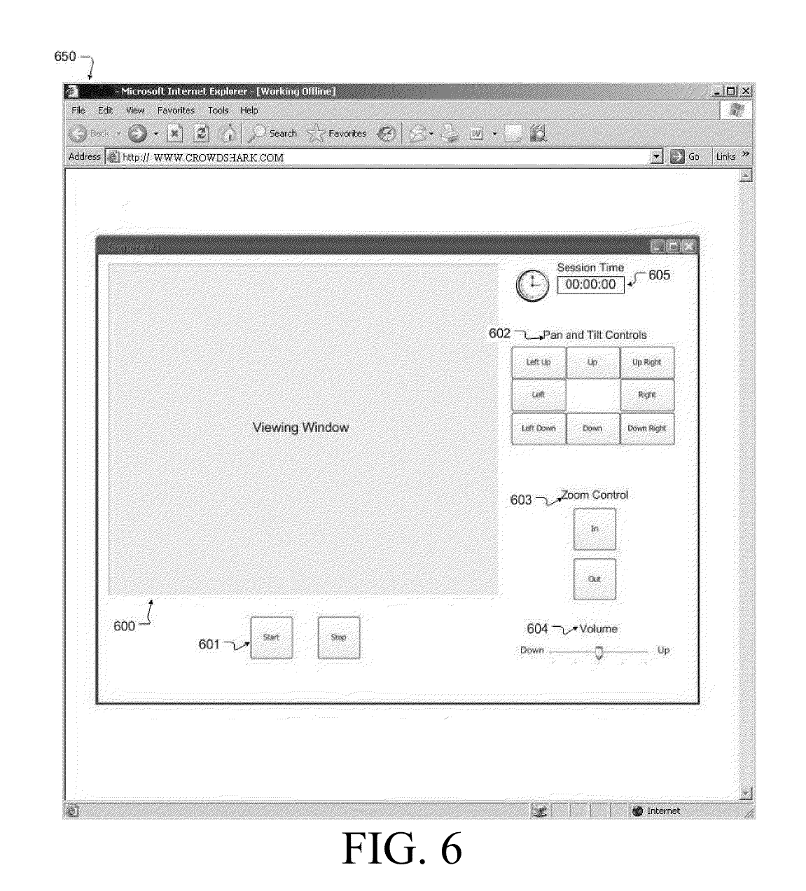

Turning now to FIG. 6, an example HTML page illustrating a TeleFamiliarization (TF) Node component control center 650, in accordance to an embodiment of the invention, is illustrated. In one embodiment, after a user 112 has selected a component 500 from the venue's floor plan, as shown in FIG. 5, the user 112 is presented with the control center console 650. The user 112 gains various capabilities depending on the status of the user. For example, if the user 112 is simply a guest user, then the user 112 may be given access to listen and watch the video stream sent from the installed audio and/or video device 118 (located at the TF Node 101) with in the viewing window 600. On the other hand, if the user 112 is a registered user, and no other user is currently controlling the selected audio and/or video device 108 of the selected TF Node 101, the user will be presented with active controls 601 that allows the user 112 to pan 602 around the room and zoom 603 the camera in so that the user 112 can better familiarize themselves with the establishment. In one embodiment, each registered user may be placed into a queue of users. In this case, if more than one user wishes to direct control of an audio and/or video device 108, the user waits in the queue for the next available time slot to gain operating control of the selected audio and/or video device 108. The current controlling user may have a limited time to control the audio and/or video device 108. In one embodiment, the user 112 may determine the amount of time remaining in their time slot by viewing the session counter 605. Other users may also be given access to the session counter 605 so that the other users can be made aware as to when the next available control slot is free. Volume control 604 may also be made available to the user 112 to adjust the loudness of the audio data being streamed from the selected TF Node 101.

The particular embodiments disclosed above are illustrative only, as the invention may be modified and practiced in different but equivalent manners apparent to those skilled in the art having the benefit of the teachings herein. Furthermore, no limitations are intended to the details of construction or design as shown herein, other than as described in the claims below. It is therefore evident that the particular embodiments disclosed above may be altered or modified and all such variations are considered within the scope and spirit of the claimed invention.

Accordingly, the protection sought herein is as set forth in the claims below.

What is claimed is:

1. A method, comprising:
selecting a location from among a plurality of locations via a computing device, wherein the plurality of locations are geographically remote from the computing device, and wherein the computing device is assignable to a first status or a second status;
transmitting a request, via the computing device, to activate one or more electronic devices located at the selected location via the computing device; and
receiving at least one of a live audio stream and a live video stream of the selected location from the one or more electronic devices in response to remotely activating the one or more electronic devices, wherein features of the one or more electronic devices are controllable when the computing device is assigned to the first status.

2. The method of claim 1, wherein the computing device is configured to transmit requests to activate a first mode of the one or more electronic devices located at the selected location when the computing device is assigned to the first status, and
wherein the computing device is configured to transmit requests to activate a second mode of the one or more electronic devices located at the selected location when the computing device is assigned to the second status.

3. The method of claim 2, further comprising:
transmitting a request to activate the first mode of the one or more electronic devices located at the selected location;
determining whether another computing device has activated the first mode of the one or more electronic devices; and
placing the request in a wait queue in response to determining that another computer device has activated the first mode of the one or more electronic devices.

4. The method of claim 3, further comprising:
initiating a timer upon placing the request in the wait queue; and
granting the request to activate the first mode of the one or more electronic devices upon expiration of the timer.

5. The method of claim 1, wherein the controllable features of the one or more electronic devices include at least one of volume control, pan control, tilt control and zoom control of the one or more electronic devices.

6. The method of claim 1, further comprising:
displaying a floor plan of the selected location, wherein the floor plan comprises one or more interactive components, wherein each of the one or more interactive components represents a location of the one or more electronic devices located within the selected location; and
transmitting a request to activate the one or more electronic devices upon selecting the one or more interactive components.

7. A method, comprising:
receiving a request from a computing device located at a first location to activate a electronic device located at a second location, wherein the first location is geographically remote from the second location;
determining whether the computing device is assigned to a first status or a second status;
transmitting at least one of a live audio stream and a live video stream of the second location via the electronic device to the computing device located at the first location; and
providing the ability to control the at least one of the live audio stream and the live video stream via the electronic device in response to determining that the computing device is assigned to the first status.

8. The method of claim 7, wherein the ability to control the at least one of the live audio stream and the live video stream is prevented in response to determining that the computing device is assigned to the second status.

9. The method of claim 7, further comprising:
receiving a first request to control the at least one of the live audio stream and the live video stream; and
placing the first request in a wait queue in response to determining that the electronic device is presently controlled via a second request received prior to the first request.

10. The method of claim 9, further comprising:
initiating a timer upon placing the first request in the wait queue; and
granting the first request to control the at least one of the live audio stream and the live video stream of the electronic device upon expiration of the timer.

11. The method of claim 7, further comprising:
transmitting a floor plan of the second location, wherein the interactive floor plan comprises one or more interactive components, wherein the interactive component represents a location of one or more electronic devices located within the second location; and
receiving a request to activate the electronic device upon an activation of the one or more interactive components.

12. A system, comprising:
one or more TeleFamiliarization Nodes, the one or more TeleFamiliarization Nodes comprising one or more electronic devices, wherein the one or more TeleFamiliarization Nodes are configured to:
receive a request to activate the one or more electronic devices, wherein the request is received from location geographically remote from the TeleFamiliarization Nodes;
determine whether the request is assigned to a first status or a second status;
transmit at least one of a live audio stream and a live video stream via the one or more electronic devices; and
provide the ability to control the at least one of the live audio stream and the live video stream via the one or more electronic devices in response to determining that the request is assigned to the first status.

13. The system of claim 12, wherein the ability to control the at least one of the live audio stream and the live video stream is prevented in response to determining that the request is assigned to the second status.

14. The system of claim 12, wherein the one or more TeleFamiliarization Nodes are further configured to:
receive a first request to control the at least one of the live audio stream and the live video stream; and
place the first request in a wait queue in response to determining that the one or more electronic devices are presently controlled via a second request received prior to the first request.

15. The system of claim 14, wherein the one or more TeleFamiliarization Nodes are further configured to:
initiate a timer upon placing the first request in the wait queue; and
grant the first request to control the at least one of the live audio stream and the live video stream of the one or more electronic devices upon expiration of the timer.

16. The system of claim 12, further comprising:
transmitting a floor plan of the one or more TeleFamiliarization Nodes, wherein the interactive floor plan comprises one or more interactive components, wherein the interactive component represents a location of the one or more electronic devices located within the TeleFamiliarization Nodes; and
receiving a request to activate the one or more electronic devices upon an activation of the one or more interactive components.

17. An apparatus, comprising:
a computing device configured to:
select a location from among a plurality of locations, wherein the plurality of locations are geographically remote from the computing device, and wherein the computing device is assignable to a first status or a second status;
transmit a request configured to activate one or more electronic devices located at the selected location; and
receive at least one of a live audio stream and a live video stream of the selected location from the one or more electronic devices in response to remotely activating the one or more electronic devices, wherein features of the one or more electronic devices are controllable when the computing device is assigned to the first status.

18. The apparatus of claim 17, wherein the computing device is further configured to:
transmit requests configured to activate a first mode of the one or more electronic devices located at the selected location when the computing device is assigned to the first status, and
transmit requests configured to activate a second mode of the one or more electronic devices located at the selected location when the computing device is assigned to the second status.

19. The apparatus of claim 18, wherein the computing device is further configured to:
transmit a request configured to activate the first mode of the one or more electronic devices located at the selected location;
determine whether another computing device has activated the first mode of the one or more electronic devices; and
place the request in a wait queue in response to determining that another computer device has activated the first mode of the one or more electronic devices.

20. The apparatus of claim 19, wherein the computing device is further configured to:
initiate a timer upon placing the request in the wait queue; and
grant the request to activate the first mode of the one or more electronic devices upon expiration of the timer.

21. The apparatus of claim 17, wherein the controllable features of the one or more electronic devices include at least one of volume control, pan control, tilt control and zoom control of the one or more electronic devices.

22. The apparatus of claim 17, further comprising:
displaying a floor plan of the selected location, wherein the floor plan comprises one or more interactive components, wherein each of the one or more interactive components represents a location of the one or more electronic devices located within the selected location; and
transmitting a request configured to activate the one or more electronic devices upon selecting the one or more interactive components.

23. A method of using the system of claim 12 for marketing purposes, comprising locating one or more of the electronic devices in an area highlighting desirable aspects of a business, location or organization.

24. The method of claim 23, further comprising staging a special event in the area such that it is captured by the live video feed or live audio feed.
